(19) United States
(12) Patent Application Publication
(10) Pub. No.: US 2011/0124486 A1
(43) Pub. Date: May 26, 2011

(54) Aluminum Titanate-Containing Ceramic-Forming Batch Materials And Methods Using The Same

(76) Inventors: Bonham Christine Gallaher, Painted Post, NY (US); Andrew Charles Gorges, Addison, NY (US); Sandra Lee Gray, Horseheads, NY (US); Christopher John Warren, Waverly, NY (US)

(21) Appl. No.: 12/624,998

(22) Filed: Nov. 24, 2009

(51) Int. Cl. C04B 38/00

(52) U.S. Cl. 501/80

(57) ABSTRACT

The present disclosure relates to aluminum titanate-containing ceramic-forming batch materials and methods using the same.

### FIELD OF THE DISCLOSURE

The disclosure relates to aluminum titanate-containing ceramic-forming batch materials and methods using the same.

### BACKGROUND

Aluminum titanate-containing ceramic bodies are viable for use in the severe conditions of exhaust gas environments, including, for example as catalytic converters and as diesel particulate filters. Among the many pollutants in the exhaust gases filtered in these applications are, for example, hydrocarbons and oxygen-containing compounds, the latter including, for example, nitrogen oxides (NOx) and carbon monoxide (CO), and carbon based soot and particulate matter. Aluminum titanate-containing ceramic bodies exhibit high thermal shock resistance, enabling them to endure the wide temperature variations encountered in their application, and they also exhibit other advantageous properties for diesel particulate filter applications, such as, for example, high porosity, low coefficient of thermal expansion (CTE), resistance to ash reaction, and a modulus of rupture (MOR) adequate for the intended application.

With engine management schemes becoming more and more sophisticated, and with catalyst compositions ever changing, there exists a need for the ability to vary or tailor the properties of these aluminum titanate-containing ceramic bodies, for example their pore size, porosity, modulus of rupture (MOR), and coefficient of thermal expansion (CTE). Moreover, there is a need for methods to make aluminum titanate-containing ceramic bodies having these desirable properties. Additionally, there is a need for methods to make aluminum titanate-containing ceramic bodies having these desirable properties using varied alumina sources.

### SUMMARY

In accordance with the detailed description and various exemplary embodiments described herein, the disclosure relates to novel aluminum titanate-containing ceramic-forming batch materials comprising inorganic materials and pore-forming materials.

In various exemplary embodiments, the inorganic materials may comprise particles from at least one alumina source, at least one titania source, at least one silica source, at least one strontium source, at least one hydrated alumina source, and at least one calcium source. In further embodiments, the median particle diameter of the at least one alumina source may range from 9.0 μm to 11.0 μm.

In various exemplary embodiments, the pore-forming materials may comprise particles from at least one graphite and at least one starch. In further embodiments, the pore-forming materials may comprise less than 20 wt % of the batch material as a super-addition.

In additional exemplary embodiments, at least one of the inorganic materials may be chosen from particles of at least one strontium source having a median particle diameter ranging from 11 μm to 15 μm; particles of at least one hydrated alumina source having a median particle diameter ranging from 10 μm to 14 μm; and particles of at least one calcium source having a median particle diameter ranging from 4.5 μm to 10 μm; and/or at least one pore-forming material may be particles of at least one graphite having a median particle diameter ranging from 40 μm to 110 μm.

The inventors have also discovered methods for making aluminum titanate-containing ceramic bodies using the batch materials of the disclosure, where in said methods may comprise: (A) preparing the batch material; (B) forming a green body from the batch material; and (C) firing the green body to obtain an aluminum titanate-containing ceramic body.

The inventors have also discovered methods of making an aluminum titanate-containing ceramic body having substantially the same median pore diameter, MOR, and/or CTE as a comparative aluminum titanate-containing ceramic body using the batch materials of the disclosure.

### BRIEF DESCRIPTION OF THE DRAWINGS

The accompanying drawings are included to provide a further understanding of the invention, and are incorporated in and constitute a part of this specification. The drawings are not intended to be restrictive of the invention as claimed, but rather are provided to illustrate exemplary embodiments of the invention and, together with the description, serve to explain the principles of the invention.

FIG. 1 is a graphical representation of the coefficient of thermal expansion, porosity, and median pore diameter of the 23 samples of aluminum titanate-containing ceramic bodies described in Example 2.

FIG. 2 is a graphical representation of the modulus of rupture of the 23 samples of aluminum titanate-containing ceramic bodies described in Example 2.

### DETAILED DESCRIPTION

It is to be understood that both the foregoing general description and the following detailed description are exemplary and explanatory only and are not restrictive of the invention, as claimed. Other embodiments will be apparent to those skilled in the art from consideration of the specification and practice of the embodiments disclosed herein. It is intended that the specification and examples be considered as exemplary only, with the true scope and spirit of the invention being indicated by the claims.

The disclosure relates to novel aluminum titanate-containing ceramic-forming batch materials. As used herein, the term “batch material,” and variations thereof, is intended to mean a substantially homogeneous mixture comprising (a) inorganic materials, (b) pore-forming materials, and (c) binders.

In various exemplary embodiments, the inorganic materials may comprise particles from at least one alumina source, at least one titania source, at least one silica source, at least one strontium source, at least one hydrated alumina source, and at least one calcium source.

Sources of alumina include, but are not limited to, powders that when heated to a sufficiently high temperature in the absence of other raw materials, will yield substantially pure aluminum oxide. Examples of such alumina sources include alpha-alumina, a transition alumina such as gamma-alumina or rho-alumina, gibbsite, corundum (Al₂O₃), boehmite (AlO(OH)), pseudoboehmite, aluminum hydroxide (Al(OH)₃), aluminum oxyhydroxide, and mixtures thereof.

In various exemplary embodiments, the at least one alumina source may comprise at least 40 wt %, at least 45 wt %, or at least 50 wt % of the inorganic materials, such as, for example, 47 wt % of the inorganic materials.

In various exemplary embodiments, one of skill in the art may choose the at least one alumina source so that the median particle diameter of the at least one source of alumina ranges from 1 μm to 45 μm or from 2 to 25 μm, such as, for example, from 9.0 μm to 11.0 μm.

In various exemplary embodiments of the present invention, the at least one source of alumina may be chosen from commercially available products, such as that sold under the designations A2-325 and A10-325 by Almatis, Inc. of Leetsdale, Pa., and those sold under the trade names Microgrit WCA20, WCA25, WCA30, WCA40, WCA45, and WCA50 by Micro Abrasives Corp. of Westfield, Mass. In at least one embodiment, the at least one alumina source is that sold under the designation A2-325.

Sources of titania include, but are not limited to, rutile, anatase, and amorphous titania. For example, in at least one embodiment, the at least one titania source may be that sold under the trade name Ti-Pure® R-101 by DuPont Titanium Technologies of Wilmington, Del.

In various exemplary embodiments, the at least one titania source may comprise at least 20 wt % of the inorganic materials, for example at least 25 wt % or at least 30 wt % of the inorganic materials.

Sources of silica include, but are not limited to, non-crystalline silica, such as fused silica or sol-gel silica, silicone resin, low-alumina substantially alkali-free zeolite, diatomaceous silica, kaolin, and crystalline silica, such as quartz or cristobalite. Additionally, the sources of silica may include silica-forming sources that comprise a compound that forms free silica when heated, for example, silicic acid or a silicon organometallic compound. For example, in at least one embodiment, the at least one silica source may be that sold under the trade name Cerasil 300 by Unimin of Troy Grove, Ill., or Imsil A25 by Unimin of Elco, Ill.

In various exemplary embodiments, the at least one silica source may comprise at least 5 wt % of the inorganic materials, for example at least 8 wt % or at least 10 wt % of the inorganic materials.

Sources of strontium include, but are not limited to, strontium carbonate and strontium nitrate. For example, in at least one embodiment, the at least one strontium source may be strontium carbonate sold under the designation Type W or Type DF, both of which are sold by Solvay & CPC Barium Strontium of Hannover, Germany.

In various embodiments, the at least one strontium source may comprise at least 5 wt % of the inorganic materials, for example at least 8 wt % of the inorganic materials. In various embodiments, one of skill in the art may choose the at least one strontium source so that the median particle diameter of the at least one strontium source ranges from 1 μm to 30 μm or from 3 to 25 μm, such as, for example, from 11 μm to 15 μm.

Sources of hydrated alumina include, but are not limited to aluminum trihydrate, boehmite (AlO(OH)) (gibbsite), pseudoboehmite, aluminum hydroxide (Al(OH)₃), aluminum oxyhydroxide, and mixtures thereof.

For example, in at least one embodiment, the at least one hydrated alumina source may be aluminum trihydrate sold under the designations SB8000 or SB432 by J.M. Huber Corporation of Edison, N.J.

In various embodiments, the at least one hydrated alumina source may comprise at least 1 wt % of the inorganic materials, for example at least 3 wt % of the inorganic materials. In various embodiments, one of skill in the art may choose the at least one hydrated alumina source so that the median particle diameter of the at least one hydrated alumina source ranges from 1 μm to 30 μm, such as for example from 10 μm to 14 μm.

Sources of calcium include, but are not limited to, ground (GCC) and precipitated (PCC) calcium carbonate. For example, in at least one embodiment, the at least one calcium source may be calcium carbonate sold under the designation Hydrocarb OG by OMYA North America Inc., of Cincinnati, Ohio or types W4 or M4 by J.M. Huber Corporation of Edison, N.J.

In various embodiments, the at least one calcium source may comprise at least 0.5 wt % of the inorganic materials, for example at least 1 wt % of the inorganic materials. In various embodiments, one of skill in the art may choose the at least one calcium source so that the median particle diameter of the at least one calcium source ranges from 1 μm to 30 μm, such as for example from 4.5 μm to 10 μm.

In various embodiments, the inorganic materials may further comprise at least one lanthanum source. Sources of lanthanum include, but are not limited to lanthanum oxide, lanthanum carbonate and lanthanum oxylate. For example, in at least one embodiment, the at least one lanthanum source may be lanthanum oxide sold under the designation type 5205 by MolyCorp Minerals, LLC, of Mountain Pass, Calif.

In various embodiments, the at least one lanthanum source may comprise at least 0.05 wt % of the inorganic materials, for example at least 0.01 wt % or 0.02 wt % of the inorganic materials. In various embodiments, one of skill in the art may choose the at least one lanthanum source so that the median particle diameter of the at least one lanthanum source ranges from 1 μm to 40 μm, such as for example from 11 μm to 15 μm.

In various exemplary embodiments, the pore-forming materials may comprise at least one graphite and at least one starch.

Sources of graphite include, but are not limited to, natural or synthetic graphite. For example, in at least one embodiment, the at least one graphite may be sold under the designations type A625, 4602, 4623, or 4740 by Asbury Graphite Mills of Asbury, N.J.

In various exemplary embodiments, one of skill in the art may choose the at least one graphite so that the median particle diameter of the at least one graphite may range from 1 μm to 400 μm, or 5 μm to 300 μm, such as for example from 40 μm to 110 μm.

Sources of starch include, but are not limited to, corn, barley, bean, potato, rice, tapioca, pea, sago palm, wheat, canna, and walnut shell flour. In at least one embodiment, the at least one starch may be chosen from rice, corn, wheat, sago palm and potato. For example, in at least one embodiment, the at least one starch may be potato starch such as native potato starch sold by Emsland-Starke GmbH of Emlichheim, Germany.

In various exemplary embodiments, one of skill in the art may choose the at least one starch so that the median particle diameter of the at least one starch may range from 1 μm to 100 μm, or 25 μm to 75 μm, such as for example from 40 μm to 50 μm.

In various exemplary embodiments, the pore-forming materials may be present in any amount to achieve a desired result. For example, the pore-forming materials may comprise at least 1 wt % of the batch material, added as a super-addition (i.e., the inorganic materials comprise 100% of the batch material, such that the total batch material is 101%). For example, the pore-forming materials may comprise at least 5 wt %, at least 10 wt %, at least 15 wt %, at least 18 wt %, or at least 20 wt % of the batch material added as a super-addition. In further embodiments, the pore-forming materials may comprise less than 20 wt % of the batch material as a super-addition, such as for example 18 wt %. In further embodiments of the disclosure, the at least one graphite may comprise at least 1 wt % of the batch material as a super-addition, for example at least 5 wt %, such as 10 wt %. In a further embodiment, the at least one starch may comprise at least 1 wt % of the batch material as a super-addition, for example at least 5 wt %, such as 8 wt %.

In various exemplary embodiments, at least one of the inorganic materials may be chosen from particles of at least one strontium source having a median particle diameter ranging from 11 μm to 15 μm; particles of at least one hydrated alumina source having a median particle diameter ranging from 10 μm to 14 μm; and particles of at least one calcium source having a median particle diameter ranging from 4.5 μm to 10 μm; and/or at least one pore-forming material may be particles of at least one graphite having a median particle diameter ranging from 40 μm to 110 μm. In further embodiments, at least two or at least three of the materials may be chosen from the group for a given batch material. In further embodiments, a batch material may comprise particles of at least one strontium source having a median particle diameter ranging from 11 μm to 15 μm; particles of at least one hydrated alumina source having a median particle diameter ranging from 10 μm to 14 μm; particles of at least one calcium source having a median particle diameter ranging from 4.5 μm to 10 μm; and particles of at least one graphite having a median particle diameter ranging from 40 μm to 110 μm

The inventors have also discovered methods for making aluminum titanate-containing ceramic bodies using the batch materials of the disclosure, wherein said methods may comprise: (A) preparing the batch material; (B) forming a green body from the batch material; and (C) firing the green body to obtain an aluminum titanate-containing ceramic body.

The batch material may be made by any method known to those of skill in the art. By way of example, in at least one embodiment, the inorganic materials may be combined as powdered materials and intimately mixed to form a substantially homogeneous mixture. The pore-forming material may be added to form a batch mixture before or after the inorganic materials are intimately mixed. In various embodiments, the pore-forming material and inorganic materials may then be intimately mixed to form a substantially homogeneous batch material. It is within the ability of one of skill in the art to determine the appropriate steps and conditions for combing the inorganic materials and at least one pore-forming material to achieve a substantially homogeneous batch material.

In additional exemplary embodiments, batch material may be mixed with any other known component useful for making batch material. For example, a binder, such as an organic binder, and/or a solvent may be added to the batch material to form a plasticized mixture. In such an embodiment, it is within the ability of one skilled in the art to select an appropriate binder. By way of example only, an organic binder may be chosen from cellulose-containing components. For example, methylcellulose, methylcellulose derivatives, and combinations thereof, may be used.

It is also within the ability of one skilled in the art to select an appropriate solvent, if desired. In various exemplary embodiments, the solvent may be water, for example deionized water.

The additional components, such as organic binder and solvent, may be mixed with the batch material individually, in any order, or together to form a substantially homogeneous mixture. It is within the ability of one of skill in the art to determine the appropriate conditions for mixing the batch material with the additional components, such as organic binder and solvent, to achieve a substantially homogeneous material. For example, the components may be mixed by a kneading process to form a substantially homogeneous mixture.

The mixture may, in various embodiments, be shaped into a ceramic body by any process known to those of skill in the art. By way of example, the mixture may be injection molded or extruded and optionally dried by conventional methods known to those of skill in the art to form a green body. In various exemplary embodiments, the green body may then be fired to form an aluminum titanate-containing ceramic body.

It is within the ability of one skilled in the art to determine the appropriate method and conditions for forming a ceramic body, such as, for example, firing conditions including equipment, temperature, and duration, to achieve an aluminum titanate-containing ceramic body, depending in part upon the size and composition of the green body. Non-limiting examples of firing cycles for aluminum titanate-containing ceramic bodies can be found in International Publication No. WO 2006/130759, which is incorporated herein by reference.

By carefully selecting the combinations of the batch materials, one may tailor the properties of aluminum titanate-containing ceramic bodies of the disclosure, for example to have a particular median pore diameter, MOR, and/or CTE. In various embodiments, this may be achieved by selecting batch materials for the disclosed aluminum titanate-containing ceramic bodies based, in part, upon the median particle size or coarseness of the materials. For example, in various embodiments disclosed herein aluminum titanate-containing ceramic bodies obtained from batch materials described herein where the at least one alumina source having a median particle diameter ranging from 9.0 μm to 11.0 μm, wherein the pore-forming material comprises less than 20 wt % of the batch material as a super-addition, and wherein at least one of the inorganic materials is chosen from: (a) particles of at least one strontium source having a median particle diameter ranging from 11 μm to 15 μm; (b) particles of at least one hydrated alumina source having a median particle diameter ranging from 10 μm to 14 μm; and (c) particles of at least one calcium source having a median particle diameter ranging from 4.5 μm to 10 μm; and/or at least one pore-forming material may be particles of at least one graphite having a median particle diameter ranging from 40 μm to 110 μm, may have a median pore diameter ranging from 13 μm to 15 μm, MOR greater than 220 psi, CTE @ 800° C. of less than 6, and/or porosity ranging from 48-52%.

The disclosure also relates to methods of making aluminum titanate-containing ceramic bodies having substantially the same median pore diameter, MOR, and/or CTE as comparative aluminum titanate-containing ceramic bodies using the batch materials of the disclosure. In further embodiments of the disclosure, the aluminum titanate-containing ceramic bodies may have substantially the same porosity as the comparative aluminum titanate-containing ceramic bodies.

By carefully selecting the combinations of the batch materials, one may tailor the properties of aluminum titanate-containing ceramic bodies of the disclosure to have substantially the same median pore diameter, MOR, and/or CTE as comparative aluminum titanate-containing ceramic bodies made with coarser alumina sources. In various embodiments, this may be achieved by selecting batch materials for the disclosed aluminum titanate-containing ceramic bodies that are coarser than those used to make the comparative aluminum titanate-containing ceramic bodies.

As used herein, the term “comparative aluminum titanate-containing ceramic body” means an aluminum titanate-containing ceramic body made from comparative batch material that is shaped and fired in substantially the same manner as the aluminum titanate-containing ceramic body of the disclosure. “Comparative batch materials” comprise the same components as the batch materials disclosed herein and vary at least in that the at least one alumina source of the comparative batch material is coarser than that of the batch material. As used herein, the term “coarser,” and variations thereof, is intended to mean that the median particle diameter of a given source of material is greater than another source of the same material. For example, an alumina source having a median particle diameter of 12 μm is coarser than an alumina source having a median particle diameter of 10 μm. Conversely, it may be said that the alumina source of the batch material of the disclosure is “finer” than that of the comparative batch material as the median particle diameter is smaller.

In at least one embodiment of the disclosure, comparative batch material may comprise inorganic materials comprising particles from at least one alumina source, at least one titania source, at least one silica source, at least one strontium source, at least one hydrated alumina source, and at least one calcium source and pore-forming materials comprising particles from at least one graphite and at least one starch. However, the at least one alumina source is coarser than that of the batch material of the disclosure.

In other embodiments of the disclosure, the particles of at least one of the at least one titania source, at least one silica source, at least one strontium source, at least one hydrated alumina source, at least one calcium source, or at least one graphite of the batch material are coarser than those of the comparative batch material. In further embodiments, at least two, at least three, or all four of the materials listed may be coarser than those of the comparative batch material.

In additional embodiments of the disclosure, the comparative batch material may have the same stoichiometry as that of the batch material of the disclosure.

In various embodiments of the present disclosure, the components of the batch material may be chosen so that aluminum titanate-containing ceramic bodies made therefrom have median pore sizes ranging from 5 μm to 35 μm, such as, for example, ranging from 13 μm to 17 μm or from 13 μm to 15 μm.

In further embodiments of the present disclosure, the components of the batch material may be chosen so that aluminum titanate-containing ceramic bodies made therefrom have porosities ranging from 30% to 65%, for example ranging from 35% to 60%, from 40% to 55%, or from 48% to 52%.

In various embodiments of the present disclosure, the aluminum titanate-containing ceramic bodies may have a MOR on cellular ware (e.g., 300 cells per square inch (cpsi)/13 mil web thickness) of 200 psi or greater, such as, for example, greater than 220 psi, such as 250 psi or greater or 300 psi or greater.

In various embodiments of the present disclosure, the aluminum titanate-containing ceramic bodies may have a CTE at 800° C. of less than 6, for example of less than 5 or less than 4.

In at least one embodiment, the aluminum titanate-containing ceramic bodies may have a median pore size ranging from 13 μm to 15 μm, a porosity ranging from 48% to 52%, a MOR of greater than 220 psi, and a CTE at 800° C. of less than 6.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the batch material” or “batch material” is intended to mean at least one batch material.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLES

The following examples are not intended to be limiting of the invention as claimed.

### Example 1

Two aluminum titanate-containing ceramic bodies were prepared using the same batch materials and amounts, but for the use of differing alumina sources. Specifically, batch A was prepared using inorganic materials comprising 46.6 wt % A10-325 alumina, 30 wt % R101 titania, 10.2 wt % Cerasil 300 silica, 8.0 wt % Type W strontium carbonate, 3.7 wt % hydrated alumina, 1.4 wt % OMYA calcium carbonate, and 0.2 wt % 5205 lanthanum oxide. Batch B was prepared using the same materials and amounts but for the use of A2-325 alumina instead of A10-325.

For both batches, the inorganic materials were combined with one another in powder form. Then pore-forming materials (10.0 wt % 4602 graphite and 8.0 wt % potato starch, as super-additions) were added to the inorganic materials and intimately mixed to produce a substantially homogeneous mixture. The median particle diameter for the batch materials are set forth in Table 1 below.

TABLE 1
Particle Sizes of Batch Materials

| Ingredient | Commercial Supplier | Type | d10 | d50 | d90 |
|---|---|---|---|---|---|
| Alumina | Almatis, Inc. | A10-325 | 5.33 | 12.17 | 29.32 |
| Alumina | Almatis, Inc. | A2-325 | 4.59 | 9.88 | 32.63 |
| Silica | Unimin Corporation | Cerasil 300 | 3.92 | 24.97 | 63.34 |
| Strontium Carbonate | Solvay CPC Barium & Strontium | Type W | 1.96 | 7.29 | 15.34 |
| Calcium Carbonate | OMYA, Inc. | Hydrocarb OG | 0.97 | 2.35 | 4.24 |
| Calcium Carbonate | J. M. Huber | HuberCarb M4 | 2.033 | 5.37 | 10.78 |
| Calcium Carbonate | J. M. Huber | HuberCarb W4 | 1.91 | 8.96 | 27.87 |
| Titania | DuPont Titanium Technologies | Ti-Pure R-101 | 0.21 | 0.56 | 1.78 |
| Aluminum Trihydrate | J. M. Huber | SB8000 | 1.72 | 3.63 | 7.12 |
| Aluminum Trihydrate | J. M. Huber | SB4000 | 3.23 | 11.56 | 26.52 |
| Lanthanum Oxide | MolyCorp, Inc. | 5205 | 5.93 | 13.57 | 30.76 |
| Potato Starch | Emsland Starke | Native Superior | 25.32 | 44.05 | 71.48 |
| Graphite | Asbury Graphite Mills | 4602 | 7.41 | 34.27 | 68.1 |
| Graphite | Asbury Graphite Mills | 4623 | 16.74 | 47.15 | 90.23 |
| Graphite | Asbury Graphite Mills | 4740 | 24.19 | 95.37 | 165.3 |
| Strontium Carbonate | Solvay CPC Barium & Strontium | Type DF | 6.17 | 12.7 | 25.43 |

Methocel, which comprised 4.5 wt % of the mixtures as a super-addition, was added as a powder to the batch materials. Then water, which comprised 16 wt % of the mixture as a super-addition, was added, and the mixtures were kneaded to form plasticized mixtures.

The plasticized mixtures were extruded to make cellular ware (e.g., 300 cells per square inch (cpsi)/13 mil web thickness), and the resulting green bodies were fired on a standard alumina titanate firing schedule as described in International Publication No. WO 2006/130759, which is incorporated herein by reference.

The resulting alumina titanate-containing ceramic bodies were analyzed. Their properties are set forth in Table 2 below.

TABLE 2
Properties of Samples A & B

| | | Median | | | | |
|---|---|---|---|---|---|---|
| | | pore | | | | |
| | % | size | CTE@ | CTE@ | Shrinkage | |
| Sample | Porosity | (μm) | 800° C. | 1000° C. | Diameter | Length |
| A | 50.86 | 15.93 | 3.7 | 7.9 | −0.29 | −0.17 |
| B | 51.12 | 12.75 | 6.9 | 10.1 | −0.53 | −0.78 |

As can be seen from the results set forth in Table 2, changing the particle size of the alumina source in the batch material affects the properties of the resulting ceramic body. Specifically, although the porosities of the materials are similar, sample A, which was made from coarser alumina, has a larger median pore size, lower CTE's and less shrinkage than Sample B.

### Example 2

Additional ceramic bodies were made to study the effect of using coarser materials in the batch material to counter the effects of the change in alumina source seen in Example 1. Twenty-three aluminum titanate-containing ceramic bodies were prepared using the batch materials and amounts set forth in Table 3 below. Again, two different alumina sources (A10-325 and A2-325) were used in the batches. Additionally, the strontium, calcium, hydrated alumina, and graphite sources were varied. The stoichiometry of the batches were all kept the same.

As seen in Table 3, samples 1, 11, and 23 were all made from the same batch composition, using A10-325 as an alumina source. These batch materials are also the same as Sample A in Example 1 above. Additionally, samples 7 and 8 were both made from the same batch composition, also using A10-325 as the alumina source. For the purposes of this example, samples 1, 7-8, 11, and 23 are comparative samples as the alumina source used in the comparative batch material, A10-325, is coarser than the alumina source, A2-325, used in the batch material for the remaining samples (samples 2-6, 9-10, and 12-22).

Aluminum titanate-containing ceramic bodies were prepared from the batch materials set forth in Table 3 using the same method disclosed in Example 1.

TABLE 3
Compositions of Samples 1-23

| | SAMPLE | | | | | | | | | | |
|---|---|---|---|---|---|---|---|---|---|---|---|
| Materials | 1 | 2 | 3 | 4 | 5 | 6 | 7 | 8 | 9 | 10 | 11 |
| SiO2 (Cerasil) | 10.19 | 10.19 | 10.19 | 10.19 | 10.19 | 10.19 | 10.19 | 10.19 | 10.19 | 10.19 | 10.19 |
| SrCO3 (Type W) | 8 | — | — | — | — | — | — | — | — | — | 8 |
| SrCO3 (Type | — | 8 | 8 | 8 | 8 | 8 | 8 | 8 | 8 | 8 | — |
| DF) | | | | | | | | | | | |
| Ca(CO)3 | 1.38 | 1.38 | — | — | — | — | — | — | — | — | 1.38 |
| (OMYA) | | | | | | | | | | | |
| CaCO3 | — | — | 1.38 | 1.38 | 1.38 | 1.38 | 1.38 | 1.38 | — | — | — |
| (HuberCarb M4) | | | | | | | | | | | |
| CaCO3 | — | — | — | — | — | — | — | — | 1.38 | 1.38 | — |
| (HuberCarb W4) | | | | | | | | | | | |
| AA203 (A10) | 46.57 | — | — | — | — | — | 46.57 | 46.57 | — | — | 46.57 |
| Al2O3 (A2) | — | 46.57 | 46.57 | 46.57 | 46.57 | 46.57 | — | — | 46.57 | 46.57 | — |
| TiO2 (R101) | 29.95 | 29.95 | 29.95 | 29.95 | 29.95 | 29.95 | 29.95 | 29.95 | 29.95 | 29.95 | 29.95 |
| Al(OH)3 | 3.71 | 3.71 | 3.71 | 3.71 | 3.71 | — | — | — | 3.71 | — | 3.71 |
| (SB8000) | | | | | | | | | | | |
| Al(OH)3 | — | — | — | — | — | 3.71 | 3.71 | 3.71 | — | 3.71 | — |
| (Huber SB432) | | | | | | | | | | | |
| La2O3 | 0.2 | 0.2 | 0.2 | 0.2 | 0.2 | 0.2 | 0.2 | 0.2 | 0.2 | 0.2 | 0.2 |
| Potato Starch | 8 | 8 | 8 | 8 | 8 | 8 | 8 | 8 | 8 | 8 | 8 |
| Graphite (4602) | 10 | 10 | 10 | — | — | — | — | — | — | 10 | — |
| Graphite (4623) | — | — | — | 10 | — | 10 | 10 | — | — | 10 | — |
| Graphite (4740) | — | — | — | — | 10 | — | — | 10 | 10 | — | — |

| | SAMPLES | | | | | | | | | | | |
|---|---|---|---|---|---|---|---|---|---|---|---|---|
| | 12 | 13 | 14 | 15 | 16 | 17 | 18 | 19 | 20 | 21 | 22 | 23 |
| SiO2 (Cerasil) | 10.19 | 10.19 | 10.19 | 10.19 | 10.19 | 10.19 | 10.19 | 10.19 | 10.19 | 10.19 | 10.19 | 10.19 |
| SrCO3 (Type W) | — | — | — | — | — | — | — | — | — | — | — | 8 |
| SrCO3 (Type | 8 | 8 | 8 | 8 | 8 | 8 | 8 | 8 | 8 | 8 | 8 | — |
| DF) | | | | | | | | | | | | |
| Ca(CO)3 | 1.38 | 1.38 | 1.38 | 1.38 | 1.38 | — | — | — | — | — | — | 1.38 |
| (OMYA) | | | | | | | | | | | | |
| Ca(CO)3 | — | — | — | — | — | 1.38 | 1.38 | — | — | — | — | — |
| (HuberCarb M4) | | | | | | | | | | | | |
| Ca(CO)3 | — | — | — | — | — | — | — | 1.38 | 1.38 | 1.38 | 1.38 | — |
| (HuberCarb W4) | | | | | | | | | | | | |
| AA203 (A10) | — | — | — | — | — | — | — | — | — | — | — | 46.57 |
| Al203 (A2) | 46.57 | 46.57 | 46.57 | 46.57 | 46.57 | 46.57 | 46.57 | 46.57 | 46.57 | 46.57 | 46.57 | — |
| TiO2 (R101) | 29.95 | 29.95 | 29.95 | 29.95 | 29.95 | 29.95 | 29.95 | 29.95 | 29.95 | 29.95 | 29.95 | 29.95 |
| Al(OH)3 | 3.71 | 3.71 | — | — | — | — | — | 3.71 | 3.71 | — | — | 3.71 |
| (SB8000) | | | | | | | | | | | | |
| Al(OH)3 | — | — | 3.71 | 3.71 | 3.71 | 3.71 | 3.71 | — | — | 3.71 | 3.71 | — |
| (Huber SB432) | | | | | | | | | | | | |
| La203 | 0.2 | 0.2 | 0.2 | 0.2 | 0.2 | 0.2 | 0.2 | 0.2 | 0.2 | 0.2 | 0.2 | 0.2 |
| Potato Starch | 8 | 8 | 8 | 8 | 8 | 8 | 8 | 8 | 8 | 8 | 8 | 8 |
| Graphite (4602) | — | — | — | — | — | 10 | — | 10 | — | 10 | — | 10 |
| Graphite (4623) | 10 | — | — | 10 | — | — | — | — | 10 | — | — | — |
| Graphite (4740) | — | 10 | — | — | 10 | — | 10 | — | — | — | 10 | — |

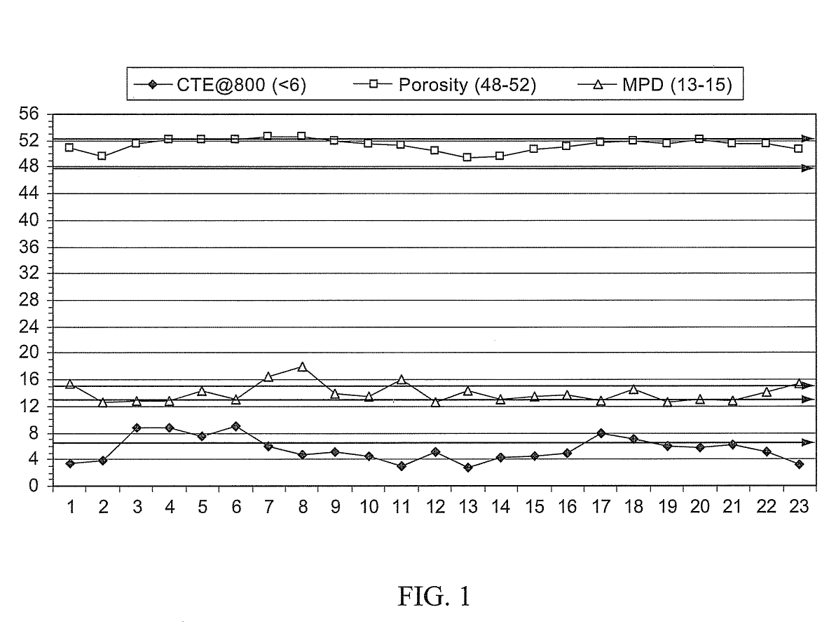

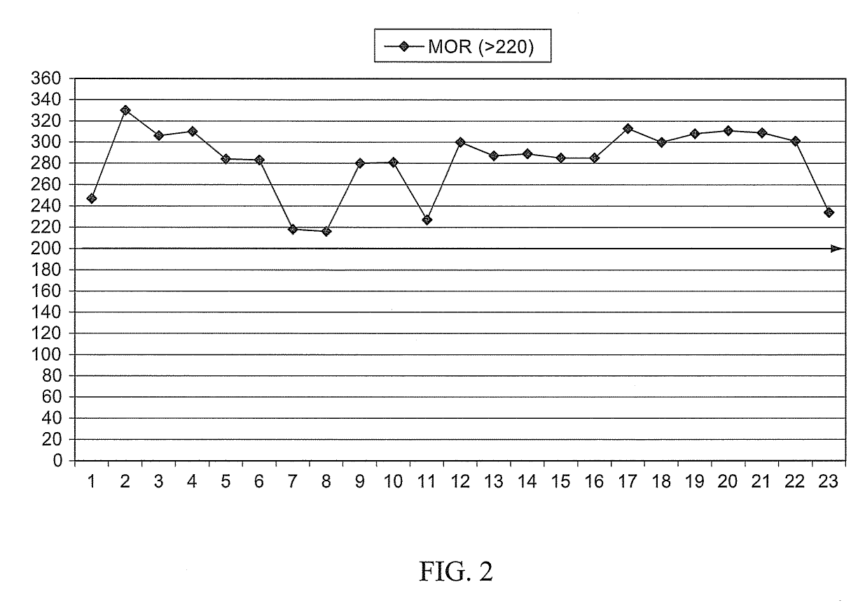

The resulting alumina titanate-containing ceramic bodies were analyzed. Their properties are set forth in FIGS. 1 and 2. Specifically, in FIG. 1, the batches are plotted as a function of CTE at 800° C., porosity, and median pore diameter (MPD). In FIG. 2, the batches are plotted as a function of MOR.

As can be seen from the data presented in FIGS. 1 and 2, most samples have a porosity within the desired range of 48-52%. Several samples, including samples 2, 13, 16, and 22 in particular, also have the desired CTE at 800° C. of less than 6, median particle diameter in the range of 13-15 μm, and MOR of greater than 220 psi.

### Example 3

Samples 24-38 were made from batch materials set forth in Examples 1 and 2. Specifically, samples 24, 29, and 34 were made using the batch material set forth in Example 1 for sample A, which includes A10-325 alumina. Samples 24, 29, and 34 may be called comparative aluminum titanate-containing ceramic bodies as the alumina source used therein is coarser than that of the other samples in this example. Specifically, the remaining samples were made using A2-325 alumina. Samples 25, 30, and 35 were made using the batch material set forth in Example 2 for sample 2. Samples 26, 31, and 36 were made using the batch material set forth in Example 2 for sample 13. Samples 27, 32, and 35 were made using the batch material set forth in Example 2 for sample 16, and samples 28, 33, and 38 were made using the batch material set forth in Example 2 for sample 22.

The ceramic bodies were made using the same procedure set forth in Example 1. The size of the die was varied as set forth in Table 4 below.

The resulting alumina titanate-containing ceramic bodies were analyzed. Their properties are set forth in Table 4.

TABLE 4
Properties of Sample 24-38

| | | | % | Median | | | |
|---|---|---|---|---|---|---|---|
| Sam- | | | Po- | Pore | | | |
| ple | Extruder/ | | ros- | Size | CTE | CTE | |
| No. | Die Size | | ity | (μm) | (@800° C.) | (@1000° C.) | MOR |
| 24 | 2 | in | 51.2 | 15.9 | 3.0 | 7.3 | 227 |
| 25 | 2 | in | 49.5 | 12.6 | 3.9 | 7.5 | 330 |
| 26 | 2 | in | 49.3 | 14.2 | 2.8 | 6.8 | 287 |
| 27 | 2 | in | 51.0 | 13.7 | 4.9 | 9.0 | 285 |
| 28 | 2 | in | 51.5 | 14.1 | 5.0 | 9.0 | 301 |
| 29 | 5.66 | in | 50.5 | 15.4 | 2.7 | 6.9 | 237 |
| 30 | 5.66 | in | 49.9 | 11.2 | 5.7 | 9.8 | 326 |
| 31 | 5.66 | in | 50.0 | 12.9 | 5.6 | 9.6 | 294 |
| 32 | 5.66 | in | 50.1 | 12.5 | 7.1 | 11.3 | 318 |
| 33 | 5.66 | in | 50.2 | 13.1 | 5.5 | 9.4 | 277 |
| 34 | 40 | mm | 50.0 | 15.0 | 2.4 | 6.7 | 243 |
| 35 | 40 | mm | 49.5 | 11.9 | 4.5 | 8.8 | 310 |
| 36 | 40 | mm | 50.3 | 13.1 | 5.1 | 9.3 | 296 |
| 37 | 40 | mm | 50.3 | 13.2 | 5.9 | 94 | 298 |
| 38 | 40 | mm | 50.3 | 13.9 | 4.6 | 8.7 | 277 |

As can be seen from Table 4, all of the samples have a porosity within the range of 48-52%, and all of the samples have a MOR of greater than 220 psi. Additionally, all but one of the samples have a CTE at 800° C. of less than 6. Finally, the median pore sizes range from 11.2 μm to 15.9 μm, with more than half ranging between 13 μm and 15 μm. Thus, it can be seen that the ceramic bodies of the disclosure may have substantially the same properties as comparative aluminum titanate-containing ceramic bodies.

What is claimed is:

1. A method for making an aluminum titanate-containing ceramic body having substantially the same median pore diameter as a comparative aluminum titanate-containing ceramic body, said method comprising:
(A) preparing batch material comprising:
(1) inorganic materials comprising particles from at least one alumina source, at least one titania source, at least one silica source, at least one strontium source, at least one hydrated alumina source, and at least one calcium source; and
(2) pore-forming materials comprising particles from at least one graphite and at least one starch;
(B) forming a green body from the batch material; and
(C) firing the green body to obtain an aluminum titanate-containing ceramic body;
wherein the comparative aluminum titanate-containing ceramic body is made from comparative batch material having the same stoichiometry as that of the batch material;
wherein the particles of the at least one of the at least one titania source, at least one silica source, at least one strontium source, at least one hydrated alumina source, at least one calcium source, or at least one graphite of the batch material are coarser than those of the comparative batch material; and
wherein the particles of the at least one alumina source of the batch material are finer than that of the comparative batch material.

2. The method for making an aluminum titanate-containing ceramic body of claim 1, wherein the porosity of the aluminum titanate-containing ceramic body is substantially the same as the porosity of the comparative aluminum titanate-containing ceramic body.

3. A method for making an aluminum titanate-containing ceramic body having substantially the same coefficient of thermal expansion (CTE) as a comparative aluminum titanate-containing ceramic body, said method comprising:
(A) preparing batch material comprising:
(1) inorganic materials comprising particles from at least one alumina source, at least one titania source, at least one silica source, at least one strontium source, at least one hydrated alumina source, and at least one calcium carbonate; and
(2) pore-forming materials comprising particles from at least one graphite and at least one potato starch;
(B) forming a green body from the batch material; and
(C) firing the green body to obtain an aluminum titanate-containing ceramic body;
wherein the comparative aluminum titanate-containing ceramic body is made from comparative batch material having the same stoichiometry as that of the batch material;
wherein the particles of at least one of the at least one titania source, at least one silica source, at least one strontium source, at least one hydrated alumina source, at least one calcium source, or at least one graphite of the batch material are coarser than those of the comparative batch material; and
wherein the particles of the at least one alumina source of the batch material are finer than that of the comparative batch material.

4. The method for making an aluminum titanate-containing ceramic body of claim 3, wherein the median pore diameter of the aluminum titanate-containing ceramic body is substantially the same as the median pore diameter of the comparative aluminum titanate-containing ceramic body.

5. A method for making an aluminum titanate-containing ceramic body having substantially the same modulus of rupture (MOR) as a comparative aluminum titanate-containing ceramic body, said method comprising:
(A) preparing batch material comprising:
(1) inorganic materials comprising particles from at least one alumina source, at least one titania source, at least one silica source, at least one strontium source, at least one hydrated alumina source, and at least one calcium carbonate; and
(2) pore-forming materials comprising particles from at least one graphite and at least one potato starch;
(B) forming a green body from the batch material; and
(C) firing the green body to obtain an aluminum titanate-containing ceramic body;
wherein the comparative aluminum titanate-containing ceramic body is made from comparative batch material having the same stoichiometry as that of the batch material;
wherein the particles of at least one of the at least one titania source, at least one silica source, at least one strontium source, at least one hydrated alumina source, at least one calcium source, or at least one graphite of the batch material are coarser than those of the comparative batch material; and
wherein the particles of the at least one alumina source of the batch material are finer than that of the comparative batch material.

6. The method for making an aluminum titanate-containing ceramic body of claim 5, wherein the median pore diameter of the aluminum titanate-containing ceramic body is substantially the same as the median pore diameter of the comparative aluminum titanate-containing ceramic body.

7. An aluminum titanate-containing ceramic-forming batch material comprising:
(a) inorganic materials comprising particles from at least one alumina source, at least one titania source, at least one silica source, at least one strontium source, at least one hydrated alumina source, and at least one calcium source;
wherein the median particle diameter of the at least one alumina source ranges from 9.0 μm to 11.0 μm; and
(b) pore-forming materials comprising particles from at least one graphite and at least one starch;
wherein the at least one pore-forming material comprises less than 20 wt % of the batch material as a super-addition;
and wherein at least one of the batch materials is chosen from:
(a) particles of at least one strontium source having a median particle diameter ranging from 11 μm to 15 μm;
(b) particles of at least one hydrated alumina source having a median particle diameter ranging from 10 μm to 14 μm;
(c) particles of at least one calcium source having a median particle diameter ranging from 4.5 μm to 10 μm; and
(d) particles of at least one graphite having a median particle diameter ranging from 40 μm to 110 μm.

8. The aluminum titanate-containing ceramic-forming batch material of claim 7, wherein at least two of the batch materials are chosen from:
(a) particles of at least one strontium source having a median particle diameter ranging from 11 μm to 15 μm;
(b) particles of at least one hydrated alumina source having a median-particle diameter ranging from 10 μm to 14 μm;
(c) particles of at least one calcium source having a median particle diameter ranging from 4.5 μm to 10 μm; and
(d) particles of at least one graphite having a median particle diameter ranging from 40 μm to 110 μm.

9. The aluminum titanate-containing ceramic-forming batch material of claim 7, wherein at least three of the batch materials are chosen from:
(a) particles of at least one strontium source having a median particle diameter ranging from 11 μm to 15 μm;
(b) particles of at least one hydrated alumina source having a median particle diameter ranging from 10 μm to 14 μm;
(c) particles of at least one calcium source having a median particle diameter ranging from 4.5 μm to 10 μm; and
(d) particles of at least one graphite having a median particle diameter ranging from 40 μm to 110 μm.

10. The aluminum titanate-containing ceramic-forming batch material of claim 7, wherein:
(a) the particles of at least one strontium source have a median particle diameter ranging from 11 μm to 15 μm;
(b) the particles of at least one hydrated alumina source have a median particle diameter ranging from 10 μm to 14 μm;
(c) the particles of at least one calcium carbonate source have a median particle diameter ranging from 4.5 μm to 10 μm; and
(d) the particles of at least one graphite have a median particle diameter ranging from 40 μm to 110 μm.

11. The aluminum titanate-containing ceramic-forming batch material of claim 7, further comprising lanthanum oxide.

12. A method for making an aluminum titanate-containing ceramic body, said method comprising:
(A) preparing batch material comprising:
(1) inorganic materials comprising particles from at least one alumina source, at least one titania source, at least one silica source, at least one strontium source, at least one hydrated alumina source, and at least one calcium source;
wherein the median particle diameter of the at least one alumina source ranges from 9.0 μm to 11.0 μm; and
(2) pore-forming materials comprising particles from at least one graphite and at least one starch;
wherein the at least one pore-forming material comprises less than 20 wt % of the batch material as a super-addition;
and wherein at least one of the batch materials is chosen from:
(a) particles of at least one strontium source having a median particle diameter ranging from 11 μm to 15 μm;
(b) particles of at least one hydrated alumina source having a median particle diameter ranging from 10 μm to 14 μm;
(c) particles of at least one calcium source having a median particle diameter ranging from 4.5 μm to 10 μm; and
(d) particles of at least one graphite having a median particle diameter ranging from 40 μm to 110 μm;
(B) forming a green body from the batch material; and
(C) firing the green body to obtain an aluminum titanate-containing ceramic body.

13. The method for making an aluminum titanate-containing ceramic body of claim 12, wherein at least two of the batch materials are chosen from:
(a) particles of at least one strontium source having a median particle diameter ranging from 11 μm to 15 μm;
(b) particles of at least one hydrated alumina source having a median particle diameter ranging from 10 μm to 14 μm;
(c) particles of at least one calcium source having a median particle diameter ranging from 4.5 μm to 10 μm; and
(d) particles of at least one graphite having a median particle diameter ranging from 40 μm to 110 μm.

14. The method for making an aluminum titanate-containing ceramic body of claim 12, wherein at least three of the batch materials are chosen from:
(a) particles of at least one strontium source having a median particle diameter ranging from 11 μm to 15 μm;
(b) particles of at least one hydrated alumina source having a median particle diameter ranging from 10 μm to 14 μm;
(c) particles of at least one calcium source having a median particle diameter ranging from 4.5 μm to 10 μm; and
(d) particles of at least one graphite having a median particle diameter ranging from 40 μm to 110 μm;

15. The method for making an aluminum titanate-containing ceramic body of claim 12, wherein:
(a) the particles of at least one strontium source have a median particle diameter ranging from 11 μm to 15 μm;
(b) the particles of at least one hydrated alumina source have a median particle diameter ranging from 10 μm to 14 μm;
(c) the particles of at least one calcium carbonate source have a median particle diameter ranging from 4.5 μm to 10 μm; and
(d) the particles of at least one graphite have a median particle diameter ranging from 40 μm to 110 μm.

16. The method for making an aluminum titanate-containing ceramic body of claim 12, wherein the aluminum titanate-containing ceramic body has a median pore diameter ranging from 13 μm to 15 μm.

17. The method for making an aluminum titanate-containing ceramic body of claim 16, wherein the aluminum titanate-containing ceramic body has a porosity ranging from 48-52%.

18. The method for making an aluminum titanate-containing ceramic body of claim 12, wherein the aluminum titanate-containing ceramic body has a modulus of rupture (MOR) of greater than 220.

19. The method for making an aluminum titanate-containing ceramic body of claim 12, wherein the aluminum titanate-containing ceramic body has a coefficient of thermal expansion (CTE) at 800° C. of less than 6.

20. The method for making an aluminum titanate-containing ceramic body of claim 12, wherein the batch material further comprises lanthanum oxide.
